(19) United States
(12) Patent Application Publication
(10) Pub. No.: US 2017/0211641 A1
(43) Pub. Date: Jul. 27, 2017

(54) Axle Flange and Brake Carrier

(71) Applicant: KNORR-BREMSE Systeme fuer Nutzfahrzeuge GmbH, Muenchen (DE)

(72) Inventor: Joerg EBERT, Koeln (DE)

(21) Appl. No.: 15/430,990

(22) Filed: Feb. 13, 2017

Related U.S. Application Data
(63) Continuation of application No. PCT/EP2015/068308, filed on Aug. 7, 2015.

(30) Foreign Application Priority Data
Aug. 11, 2014 (DE) 10 2014 111 405.1

(51) Int. Cl. F16D 65/04; F16D 51/20; F16D 55/22

(52) U.S. Cl. CPC F16D 65/04; F16D 55/22; F16D 51/20; F16D 2055/0008

(57) ABSTRACT

In an axle flange, in particular of a commercial vehicle, which is arranged on a wheel axle of a motor vehicle, having at least one flange surface which has a plurality of through holes for connection to a brake carrier, wherein fasteners can be guided through the through holes, the through holes are arranged in such a way that they are adapted firstly to the hole pattern of a brake carrier of a disc brake and secondly to the hole pattern of a brake carrier of a self-supporting drum brake.

### CROSS REFERENCE TO RELATED APPLICATIONS

This application is a continuation of PCT International Application No. PCT/EP2015/068308, filed Aug. 7, 2015, which claims priority under 35 U.S.C. §119 from German Patent Application No. 10 2014 111 405.1, filed Aug. 11, 2014, the entire disclosures of which are herein expressly incorporated by reference.

### BACKGROUND AND SUMMARY OF THE INVENTION

The present invention relates to an axle flange arranged on a wheel axle of a motor vehicle, and to a brake carrier for a disc brake, as well as to a brake carrier for a self-contained drum brake.

Generic axle flanges are known, for example, from DE 10 2007 013 670 A1, which discloses an approximately semicircular axle flange which is matched in particular to the fastening requirements of a drum brake.

In order to fasten a brake carrier of a disc brake to an axle flange configured in such a way, the brake carrier accordingly has to have a semicircular flange surface with a corresponding hole pattern in order for it to be possible to fasten the brake carrier to the axle flange tailored to an anchor plate of a drum brake.

The object of the present invention is to provide an axle flange which is arranged in a wheel hub and to which both a brake carrier of a disc brake with a standard hole pattern and a brake carrier of what is known as a self-contained drum brake is able to be fastened.

The object is achieved by an axle flange arranged on a wheel axle of a motor vehicle, in particular of a commercial vehicle, having a plurality of through-bores for connecting to a brake carrier, wherein fasteners are able to be passed through the through-bores. The axle flange has at least two spaced-apart flange surfaces, wherein the through-bores are arranged so as to match the hole pattern of a brake carrier for a disk brake and also match the hole pattern of a brake carrier for a self-contained drum brake.

According to the invention, the axle flange arranged on the wheel axle has a plurality of through-bores for connecting to a brake carrier, wherein fasteners, for example screws or bolts, are able to be passed through said through-bores. In this case, the axle flange has at least two spaced-apart flange surfaces, wherein the through-bores are arranged in the flange surfaces such that they match the hole pattern of a connection flange of a brake carrier for a disc brake and also match the hole pattern of a connection flange of a brake carrier for a self-contained drum brake.

This allows an axle provided with such an axle flange to be able to be used both for the use of disc brakes and for self-contained drum brakes, without additional adapter pieces having to be installed in order to be able to fasten corresponding brake carriers for the disc brake or the drum brake to the axle flange.

The at least two flange surfaces that are arranged in a spaced-apart manner make it possible to keep the axle flange structurally small, wherein the weight of the axle flange is also noticeably reduced compared with axle flanges known from the prior art.

According to one advantageous embodiment variant of the invention, the flange surfaces are arranged at an angle of 100° to 140° with respect to one another, thereby ensuring high stability of the connection between the axle flange and the brake carrier, fastened thereto, of the disc brake or drum brake.

In this case, each of the flange surfaces preferably has at least two through-bores. In this case, according to a further preferred embodiment variant, the through-bores in the flange surfaces are arranged such that the distance thereof from the center of the wheel axle is no more than 150% of the radius of the wheel axle and as a result keeps the installation space of the axle flange small.

The machining of the axle flange, allowed by the design according to the invention of the axle flange, by turning in one setup also ensures very precise positioning of the brake with respect to the drum or to the brake disc, this having an advantageous effect on right-hand/left-hand braking and on noise generation in the case of drum brakes.

According to a further advantageous configuration of the invention, each of the flange surfaces has three through-bores, of which two through-bores are arranged at the same distance from the center of the wheel axle, and particularly preferably the third of the through-bores is arranged farther away from the center of the wheel axle than the two through-bores that are arranged at the same distance from the center of the wheel axle.

The brake carrier according to the invention of a disc brake is distinguished by the fact that the through-bores in the connection flange of the brake carrier are arranged such that they at least partially match the hole pattern of the flange surface of an axle flange of a wheel axle according to the invention.

In a corresponding manner, a brake carrier of a self-contained drum brake is configured such that the through-bores in the connection flange of the brake carrier of the self-contained drum brake are arranged such that they at least partially match the hole pattern of the flange surface of the axle flange of a wheel axle according to the invention.

As a result, the self-contained drum brake can be assembled in the fully preassembled state, thereby reducing assembly costs. Furthermore, the downtime for repairs is shortened since the complete drum brake is replaced by releasing the fasteners, preferably 6 bolts.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective illustration of an embodiment variant of an axle flange according to the invention.

FIG. 2 is a perspective illustration of a disc brake fastened to the axle flange according to FIG. 1.

FIG. 3 is a further perspective illustration of the disc brake fastened to the axle flange according to FIG. 1, with the fastening of the brake carrier to the axle flange being illustrated.

FIG. 4 is a perspective view of a drum brake fastened to the axle flange according to FIG. 1.

FIG. 5 is a further perspective view of the drum brake from FIG. 4, mounted on the axle flange according to FIG. 1, with the fastening of the brake carrier to the axle flange being illustrated.

FIGS. 6 and 7 are perspective views of the brake carrier of the drum brake.

### DETAILED DESCRIPTION OF THE DRAWINGS

In the following description of the figures, terms such as top, bottom, left, right, front, rear, etc. refer exclusively to the exemplary illustration and position of the axle flange, drum brake, disc brake, brake carrier and the like selected in the respective figures. These terms should not be understood as limiting, i.e. these references can change as a result of different operating positions or the mirror-symmetrical layout or the like.

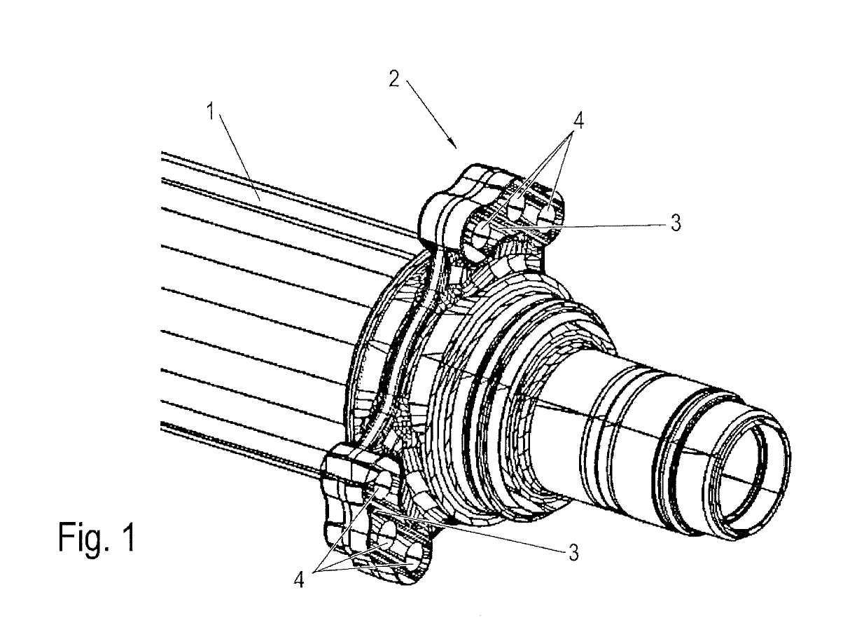

In FIG. 1, a wheel axle of a motor vehicle, in particular a commercial vehicle, is designated overall by the reference sign 1. An axle flange 2 is fastened to this wheel axle 1.

In the preferred embodiment variant shown in FIG. 1, the axle flange 2 has two flange surfaces 3 that protrude outward radially with respect to the longitudinal axis of the wheel axle 1.

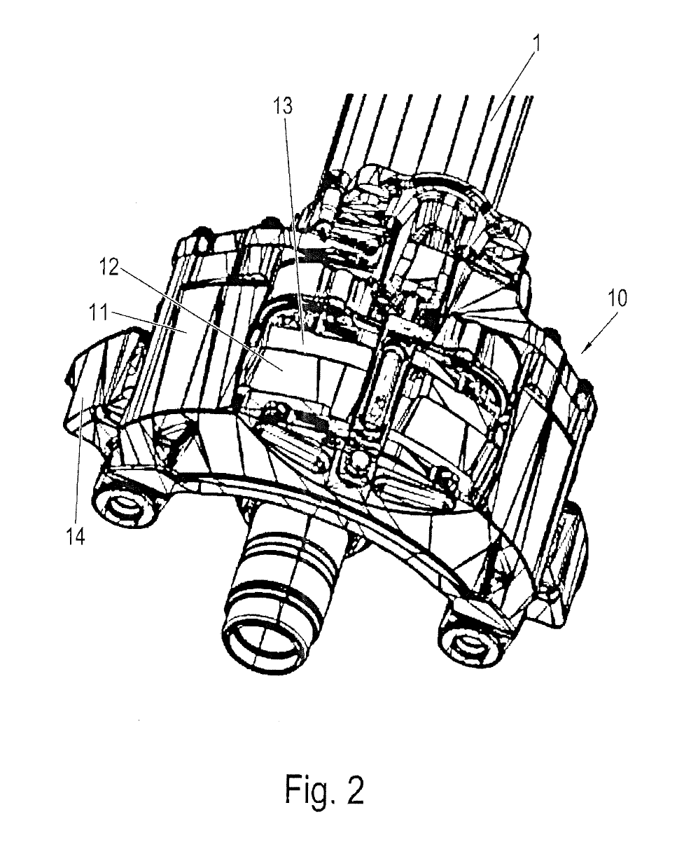

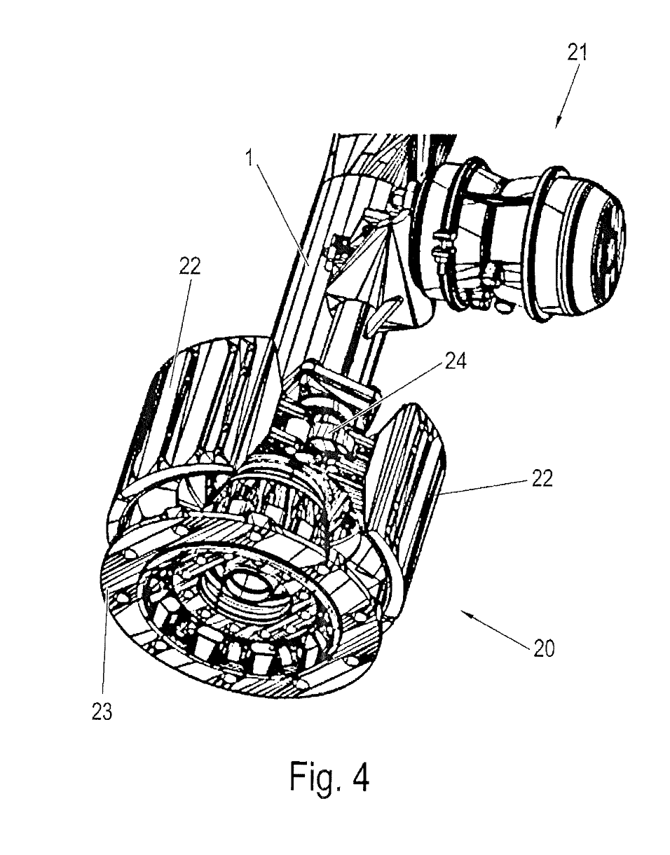

Through the flange surfaces 3, parallel to the longitudinal axis of the wheel axle 1, there extend through-bores 4, through which fasteners 16, 28, for example screws or bolts, are able to be passed in order to mount a brake carrier 14 of a disc brake 10, shown in FIG. 2, or a brake carrier 25 of a self-contained drum brake 20, shown in FIG. 4, and by way of which the brake carriers 14, 25 are able to be fastened to the axle flange 2.

The flange surfaces 3 and through-bores 4 provided therein are in this case arranged such that they match the hole pattern of the brake carrier 14 of the disc brake 10 and also the hole pattern of the brake carrier 25 of the self-contained drum brake 20.

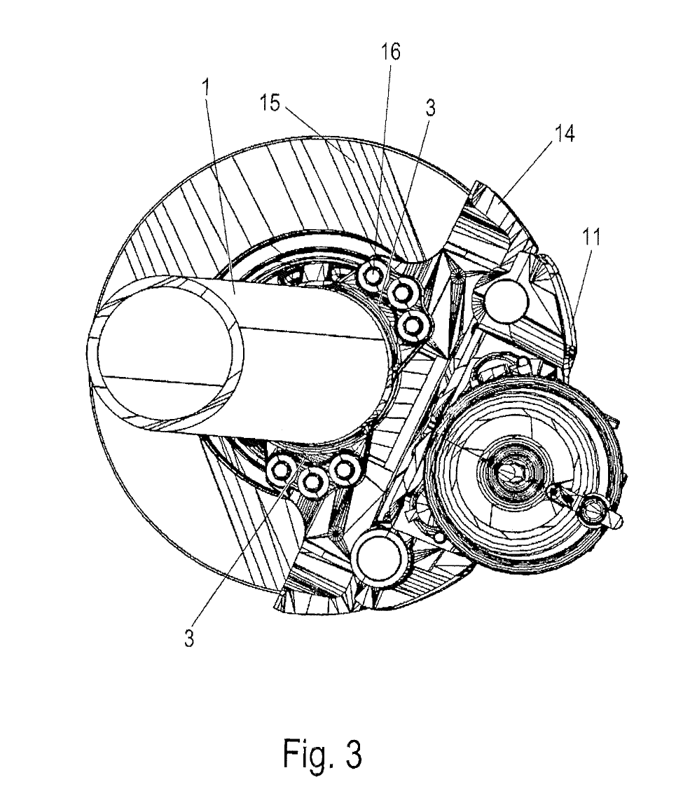

A disc brake mounted on a wheel axle 1 with such an axle flange 2 is shown in FIGS. 2 and 3.

A drum brake 20 mounted on a wheel axle 1 with such an axle flange 2 is illustrated in FIGS. 4 to 7.

As can also be seen in FIG. 1, in the embodiment variant of the axle flange 2 that is shown here, the flange surfaces 3 are arranged at an angle of 100° to 140° relative to one another in the circumferential direction of the wheel axle 1, thereby ensuring that a brake carrier 14 of a disc brake 10 and also a brake carrier 25 of a self-contained drum brake 20 are mounted securely.

Each of the flange surfaces 3 of the axle flange 2 has in this case at least two through-bores 4, such that the brake carriers 10, 14 can be secured to each of the flange surfaces 3 of the axle flange 2 with two fasteners 16, 28 that are preferably in the form of bolts or screws.

According to the embodiment variant of the axle flange 2 that is shown in FIG. 1, three such through-bores 4 are provided in each of the flange surfaces 3.

In this case, two of the through-bores 4 are preferably arranged at the same distance from the center of the wheel axle 1. The third through-bore 4 is preferably arranged farther away from the center of the wheel axle 1 than the two through-bores 4 that are arranged at the same distance from the center of the wheel axle 1.

Here, the through-bore 4 that is arranged farther away from the center of the wheel axle 1 is preferably the middle through-bore 4, which, as seen in the circumferential direction, is arranged between the two through-bores 4 that are arranged at the same distance from the center of the wheel axle 1.

Overall, the flange surfaces 3 of the axle flange 2 and the through-bores 4 in the flange surfaces 3 are integrally formed on or drilled in the wheel axle as close as possible to the center of the wheel axle 1.

In particular, the through-bores 4 in the flange surfaces 3 are arranged such that the distance thereof from the center of the wheel axle 1 is no more than 150% of the radius of the wheel axle 1.

In the embodiment variant, shown in FIG. 2, of the brake carrier 14 of a disc brake 10, the brake carrier 14 is provided with a plurality of through-bores for connecting to the axle flange 2 of the wheel axle 1.

Mounted on the brake carrier 14 is a brake caliper 11 having a pad well in which two brake pads 13 are inserted. Located in the gap 12 between the brake pads 13 in the fully mounted state of the disc brake is the brake disc 15, shown in FIG. 3, which is positioned on the rotatable part of the wheel axle 1 and rotates together with the vehicle wheel in operation.

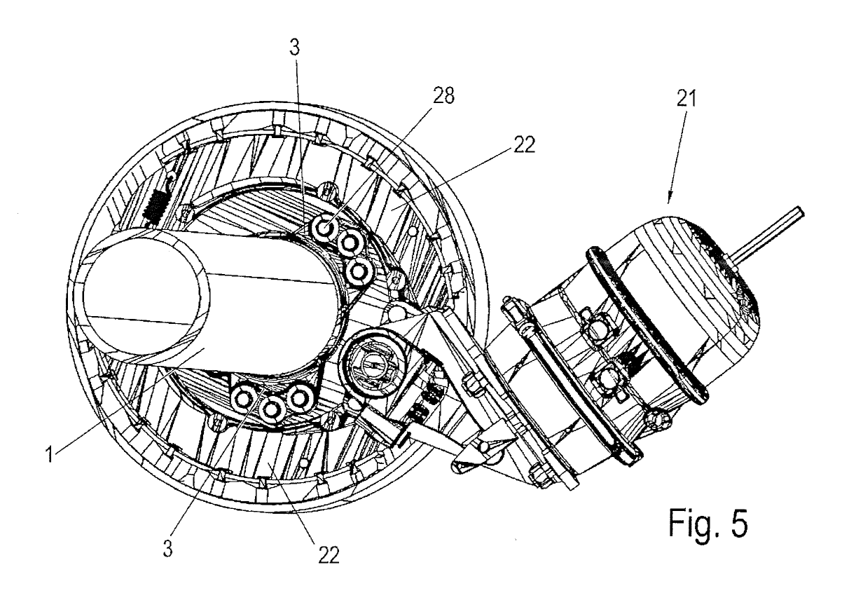

FIGS. 4 and 5 show the arrangement of a self-contained drum brake 20 on the wheel axle 1. The drum brake 20 is provided with two brake shoes 22 which are able to be spread via an S-cam 24 and are each able to be pressed against the inner wall of a drum (not illustrated here). The S-cam 24 is driven in this case via a wheel brake cylinder 21. Mounted on the wheel-side end of the wheel axle 1 is a wheel hub 23 which rotates together with the brake drum and against which the brake pads 22 are pressed radially outwardly during a braking operation.

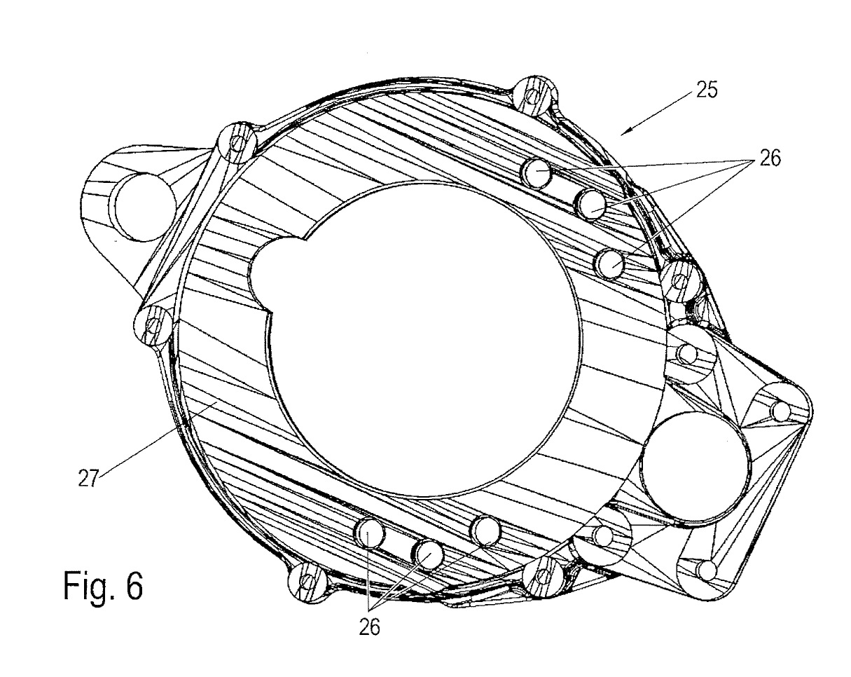

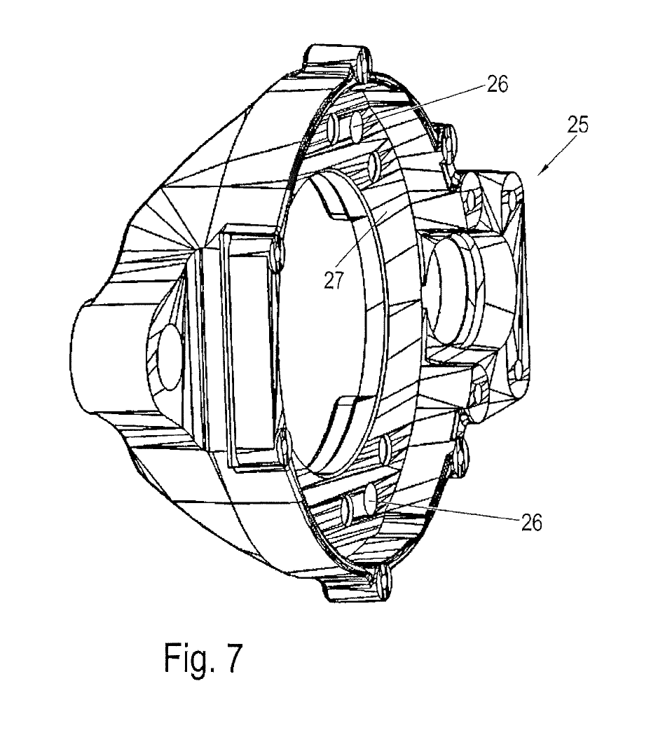

A brake carrier 25 of said drum brake 20, on which brake carrier 25 the wheel brake cylinder 21 and also the brake pads 22 and further mechanisms of the drum brake that is known per se are held, is in this case provided, as shown in detail in FIGS. 6 and 7, with a flange ring 27 via which the brake carrier is secured to the flange surfaces 3 of the axle flange 2.

In this case, the flange ring 27 has, preferably at an angular spacing of 100° to 140°, respective groups of through-bores 26, wherein the hole pattern of the flange ring 27 corresponds to the hole pattern of the flange surfaces 3 of the axle flange 2.

Overall, the circumscribed wheel flange 2 of the wheel axle 1 is thus suitable for fastening both a disc brake 10 and a self-contained drum brake without further effort or adaptor pieces. The above-described axle flange 2 is suitable not only for single tires but also for dual tires and for super single tires.

### LIST OF REFERENCE SIGNS

1 Wheel axle
2 Axle flange
3 Flange surfaces
4 Through-bores
10 Disc brake
11 Brake caliper
12 Gap
13 Brake pads
14 Brake carrier
15 Brake disc
16 Fastener
20 Drum brake
21 Brake cylinder
22 Brake shoes
23 Wheel hub
24 S-cam
25 Brake carrier
26 Through-bore
27 Flange ring
28 Fastener

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. An axle flange arranged on a wheel axle of a motor vehicle, comprising:
at least two spaced-apart flange surfaces;
a plurality of through-bores arranged in the at least two spaced-apart flange surfaces, wherein
the plurality of through-bores are configured to allow fasteners to be passed through the through-bores, and
the through-bores are arranged so as to match a hole pattern of a brake carrier for a disc brake and also match a hole pattern of a brake carrier for a self-contained drum brake.

2. The axle flange as claimed in claim 1, wherein the flange surfaces are arranged at an angle of 100° to 140° with respect to one another.

3. The axle flange as claimed in claim 1, wherein each of the flange surfaces has at least two through-bores.

4. The axle flange as claimed in claim 3, wherein the through-bores in the flange surfaces are arranged such that a distance thereof from the center of a wheel axle is no more than 150% of a radius of the wheel axle.

5. The axle flange as claimed in claim 1, wherein the through-bores in the flange surfaces are arranged such that a distance thereof from the center of a wheel axle is no more than 150% of a radius of the wheel axle.

6. The axle flange as claimed in claim 1, wherein each of the flange surfaces has three through-bores, of which two through-bores are arranged at a same distance from a center of the wheel axle.

7. The axle flange as claimed in claim 6, wherein a third of the three through-bores is arranged farther away from the center of the wheel axle than the two through-bores that are arranged at the same distance from the center of the wheel axle.

8. The axle flange as claimed in claim 2, wherein each of the flange surfaces has three through-bores, of which two through-bores are arranged at a same distance from a center of the wheel axle.

9. The axle flange as claimed in claim 8, wherein a third of the three through-bores is arranged farther away from the center of the wheel axle than the two through-bores that are arranged at the same distance from the center of the wheel axle.

10. The axle flange as claimed in claim 1, wherein the axle flange is for a commercial vehicle wheel axle.

11. The axle flange as claimed in claim 1, wherein the brake carrier is a disc brake brake carrier that connects to the flange surfaces via the fasteners.

12. The axle flange as claimed in claim 1, wherein the brake carrier is a self-contained drum brake brake carrier that connects to the flange surfaces via the fasteners.

13. An axle flange system on a wheel axle of a commercial motor vehicle, comprising:
an axle flange having at least two spaced-apart flange surfaces;
a plurality of through-bores arranged in each of the at least two spaced-apart flange surfaces, the through-bores being configured to allow fasteners to pass through the through-bores;
a brake carrier for a disc brake, the brake carrier having a plurality of through-bores;
a brake carrier for a self-contained drum brake, the brake carrier for the self-contained drum brake having a plurality of through-bores, wherein
the through-bores arranged in the at least two spaced-apart flange surfaces are arranged so as to match a hole pattern of the plurality of through-bores of both the disc brake brake carrier and the drum brake brake carrier.
